(19) United States
(12) Patent Application Publication
(10) Pub. No.: US 2025/0179298 A1
(43) Pub. Date: Jun. 5, 2025

(54) ASPHALT PELLET WITH CALCINED GYPSUM SHELL

(71) Applicant: CERTAINTEED LLC, Malvern, PA (US)

(72) Inventors: William R. BAILEY, Tumwater, WA (US); William P. DEMPSEY, Issaquah, WA (US)

(21) Appl. No.: 18/816,238

(22) Filed: Aug. 27, 2024

Related U.S. Application Data
(60) Provisional application No. 63/606,131, filed on Dec. 5, 2023.

(51) Int. Cl. C08L 95/00; C08K 3/30

(52) U.S. Cl. CPC C08L 95/00; C08K 3/30; C08K 2003/3045; C08L 2207/22; C08L 2207/53

(57) ABSTRACT

According to one aspect, an asphalt pellet can include a core including an asphalt binder, and a shell including calcined gypsum. The shell may provide for improved durability and storage as compared to other asphalt pellet shells.

### CROSS-REFERENCE TO RELATED APPLICATION(S)

This Application claims priority under 35 U.S.C. § 119(e) to U.S. Provisional Patent Application No. 63/606,131, entitled “ASPHALT PELLET WITH STUCCO SHELL,” filed Dec. 5, 2023, by William R. BAILEY et al., which is assigned to the current assignee hereof and is incorporated herein by reference in its entirety.

### FIELD OF THE DISCLOSURE

The following is directed to shelled asphalt pellets including calcined gypsum in the shell.

### SUMMARY

According to one aspect, an asphalt pellet can include a core including an asphalt binder, and a shell including calcined gypsum. The shell may provide for improved durability and storage as compared to other asphalt pellet shells.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a pellet according to an embodiment.

FIG. 2 includes an illustration of an exemplary system for forming asphalt pellets according to an embodiment.

FIG. 3 includes load vs displacement curves for crush strength testing.

### DETAILED DESCRIPTION

The following is directed to asphalt pellets for pavement compositions including shells that contain calcined gypsum, providing for improved durability and storage.

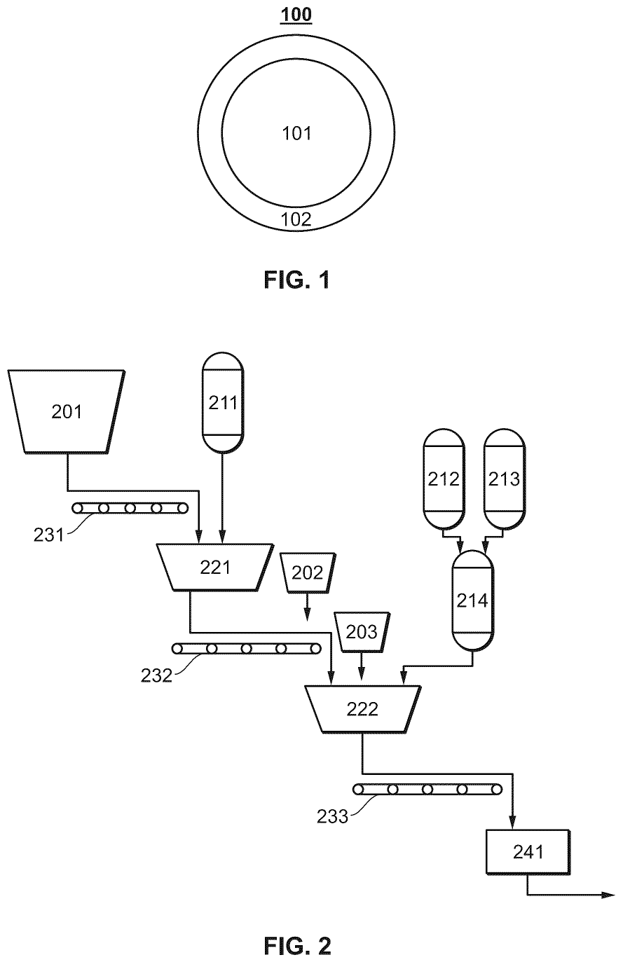

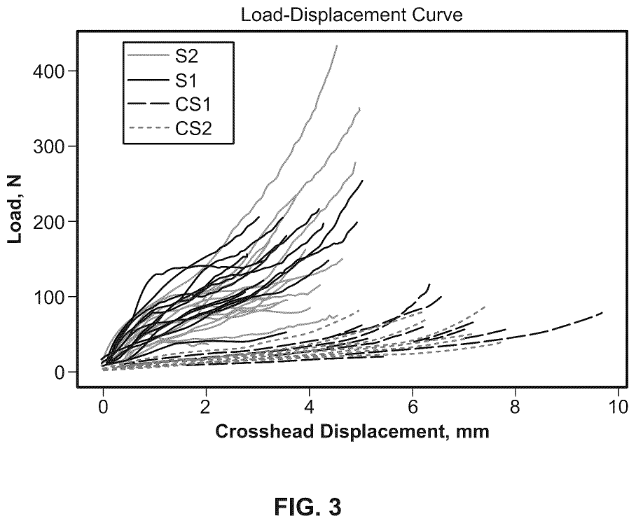

FIG. 1 includes an illustration of a pellet 100 according to an embodiment. The pellet 100 can have a core 101 and a shell 102. The pellets are suitable for various storage and transportation conditions.

FIG. 2 includes an illustration of an exemplary system for forming pellets according to an embodiment. The system begins with an asphalt binder hopper 201. Asphalt from asphalt binder hopper 201 can be transported via conveyer belt 231 to pelletizer disc 221. The asphalt binder can be agglomerated or pelletized with a softening agent from tank 211 to form pellet cores 101. The cores can have a diameter between 0.01 and 0.5 inches. Alternatively, the cores can have a maximum diameter of 0.75 inches or 1 inch or 1.5 inches or 2 inches.

In an embodiment, the core may include a particular asphalt binder that may provide for improved performance and or manufacturing of the pellets. The asphalt binder may also provide for reduced environmental impact. In an embodiment, the core can include asphalt shingle waste. The asphalt shingle waste can include post industrial waste, post consumer waste, or a combination thereof. The asphalt shingle waste can be in a size from about 20-40 mesh to about 0.25 inches.

In an embodiment, the cores 101 may include a particular amount of asphalt shingle waste that may facilitate improved performance and/or manufacturing of the asphalt pellets. The shingle waste content may also provide for reduced environmental impact. In an embodiment, the core can include at least 5 wt. % asphalt shingle waste or at least 10 wt. % or at least 15 wt. % or at least 20 wt. % or at least 25 wt. % or at least 30 wt. % or at least 35 wt. % or at least 40 wt. % or at least 45 wt. % or at least 50 wt. % or at least 55 wt. % or at least 60 wt. % or at least 65 wt. % or at least 70 wt. % or at least 75 wt. % or at least 80 wt. % or at least 85 wt. % or at least 90 wt. % asphalt shingle waste. In another embodiment, the core can include no greater than 99 wt. % asphalt shingle waste or no greater than 98 wt. % or no greater than 97 wt. % or no greater than 96 wt. % or no greater than 95 wt. % asphalt shingle waste. It will be appreciated that the core can include a range of asphalt shingle waste between any of the minimum and maximum values noted above, including for example, at least 10 w % and not greater than 99 wt. % or at least 90 wt. % and not greater than 96 wt. %.

In an embodiment, the core can comprise a softening agent. The softening agent can have a particular composition that may facilitate improved performance and/or manufacturing of the asphalt pellets. The softening agent composition may also provide for reduced environmental impact. In an embodiment, the softening agent can comprise a petroleum distillate, performance grade asphalt, bio-oil, a vegetable oil, biofuel, a biodiesel, a biodiesel residue oil, Tall-oil, heavy vacuum gas oil (HVGO), fatty acid methy esters (FAME), reclaimed motor oil, reclaimed cutting oil, pine tar or a combination thereof. In a particular embodiment, the softening agent can include biodiesel residue oil.

In an embodiment, the cores 101 may include a particular amount of softening agent that may facilitate improved performance and/or manufacturing of the asphalt pellets. The softening agent content may also provide for reduced environmental impact. In an embodiment, the core can include at least 1 wt. % softening agent or at least 2 wt. % or at least 3 wt. % or at least 4 wt. % or at least 5 wt. % or at least 6 wt. % or at least 7 wt. % or at least 8 wt. % softening agent. In another embodiment, the core can include no greater than 30 wt. % softening agent or no greater than 25 wt. % or no greater than 20 wt. % or no greater than 15 wt. % or no greater than 10 wt. %. It will be appreciated that the core can include a range of softening agent between any of the minimum and maximum values noted above, including for example, at least 1 wt. % and not greater than 10 wt. % or at least 5 wt. % and not greater than 10 wt. %.

In an embodiment, the core can comprise an additive. The additive can have a particular composition that may facilitate improved performance and/or manufacturing of the asphalt pellets. The additive composition may also provide for reduced environmental impact. In an embodiment, the additive can comprise tire rubber, asphalt, aramid fibers, carbon, asphalt additives, glass, recycled material, recycled asphalt pavement, Fisher-Tropsch wax, soy wax, zeolites, high density polyethylethe (HDPE), low density polyethelene (LDPE), ethylene-vinyl acetate (EVA), polyvinyl chloride (PVC), an emulsifying agent, polyciclic aromatic hydrocarbons (PAHs), sodium polyacrylate polymers, styrene butadiene styrene rubbers (SBS), styrene butadiene rubbers (SBR), paper, comprises carbon black, a colorant, cellulose, or a combination thereof.

Following pelletizer disc 221, the cores 101 can be transported to pelletizer disc 222 via conveyer belt 232. The pellets can be dusted with mineral fines from hopper 202. Then the cores are agglomerated with a shell composition in pelletizer disc 222 to form a shell 102 over cores 101. The shelled pellets can have a diameter of 0.01 inches to 1 inch. The shelled pellets can comprise 80-90 wt. % core and 10-20 wt. % shell. In an alternative embodiment, the cores can be agglomerated with the shell composition in the same pelletizer disc used to form the cores.

In an embodiment, the shell composition may have a particular composition that may facilitate improved performance and/or manufacturing of the asphalt pellets. The shell composition may also provide for reduced environmental impact. In an embodiment, the shell composition can include calcined gypsum, sometimes colloquially referred to as stucco. The calcined gypsum can include calcium sulfate hemihydrate. The calcined gypsum can further include other additives. In an embodiment, the calcined gypsum can be recycled gypsum, such as gypsum from recycled plasterboards. The calcined gypsum can include a particular sulfur content and/or calcium content. In an embodiment, the shell composition can further include recycled polyethylene, a water-resistant polymer, a wax, mineral fines, or ground plastic fines, or a combination thereof. In a more particular embodiment, the shell composition can include mineral fines. In an even more particular embodiment, the shell composition can include lime fines. In an even more particular composition, the shell can include hydrated lime. These materials can be deposited into pelletizer disc 222 via hopper 203.

In an embodiment, the shell composition may include a particular content of calcined gypsum that may facilitate improved performance and/or manufacturing of the asphalt pellets. The calcined gypsum content may also provide for reduced environmental impact. In an embodiment the shell can include at least 5 wt. % calcined gypsum or at least 10 wt. % or at least 15 wt. % or at least 20 wt. % or at least 25 wt. % or at least 30 wt. % or at least 35 wt. % or at least 40 wt. % or at least 45 wt. % or at least 50 wt. % or at least 55 wt. % or at least 60 wt. % or at least 65 wt. % or at least 70 wt. % or at least 75 wt. % or at least 80 wt. % or at least 85 wt. % or at least 90 wt. % or at least 95 wt. % or at least 97 wt. % calcined gypsum. In an embodiment, the shell can include no greater than 99 wt. % calcined gypsum or no greater than 90 wt. % or no greater than 80 wt. % or no greater than 70 wt. % or no greater than 60 wt. % or no greater than 50 wt. % or no greater than 40 wt. % or no greater than 30 wt. % or no greater than 20 wt. % or no greater than 10 wt. % calcined gypsum. It will be appreciated that the calcined gypsum content can be between any of the minimum and maximum values noted above, including for example, but not limited to, at least 80 wt. % and not greater than 99 wt. % or at least 95 wt. % and no greater than 99 wt. %.

In an embodiment, the calcined gypsum may include a particular calcium content that may facilitate improved performance and/or manufacturing of the asphalt pellets. In an embodiment, the calcined gypsum may include a calcium content of 20-25 wt. % calcium content for a total weight of the calcined gypsum.

In an embodiment, the calcined gypsum may include a particular sulfur content that may facilitate improved performance and/or manufacturing of the asphalt pellets. In an embodiment, the calcined gypsum may include a sulfer content of 15-20 wt. % sulfur content for a total weight of the calcined gypsum.

In an embodiment, the calcined gypsum may have a particular pH content that may facilitate improved performance and/or manufacturing of the asphalt pellets. In an embodiment, the calcined gypsum may have pH between 7 and 11, or between 7 and 10, or between 7 and 8.

In an embodiment, the shell composition may include a particular mineral fines content that may facilitate improved performance and/or manufacturing of the asphalt pellets. The mineral fines content may also provide for reduced environmental impact. In an embodiment the shell can include at least 5 wt. % mineral fines or at least 10 wt. % or at least 15 wt. % or at least 20 wt. % or at least 25 wt. % or at least 30 wt. % or at least 35 wt. % or at least 40 wt. % or at least 45 wt. % or at least 50 wt. % or at least 55 wt. % or at least 60 wt. % or at least 65 wt. % or at least 70 wt. % or at least 75 wt. % or at least 80 wt. % or at least 85 wt. % or at least 90 wt. % or at least 95 wt. % or at least 97 wt. % mineral fines. In an embodiment, the shell can include no greater than 99 wt. % mineral fines or no greater than 90 wt. % or no greater than 80 wt. % or no greater than 70 wt. % or no greater than 60 wt. % or no greater than 50 wt. % or no greater than 40 wt. % or no greater than 30 wt. % or no greater than 20 wt. % or no greater than 10 wt. % mineral fines. It will be appreciated that the mineral fines content can be between any of the minimum and maximum values noted above, including for example, but not limited to, at least 80 wt. % and not greater than 99 wt. % or at least 95 wt. % and no greater than 99 wt. %.

In an embodiment, the shell composition may include a particular content lime fines that may facilitate improved performance and/or manufacturing of the asphalt pellets. The lime fines content may also provide for reduced environmental impact. In an embodiment the shell can include at least 5 wt. % lime fines or at least 10 wt. % or at least 15 wt. % or at least 20 wt. % or at least 25 wt. % or at least 30 wt. % or at least 35 wt. % or at least 40 wt. % or at least 45 wt. % or at least 50 wt. % or at least 55 wt. % or at least 60 wt. % or at least 65 wt. % or at least 70 wt. % or at least 75 wt. % or at least 80 wt. % or at least 85 wt. % or at least 90 wt. % or at least 95 wt. % or at least 97 wt. % lime fines. In an embodiment, the shell can include no greater than 99 wt. % lime fines or no greater than 90 wt. % or no greater than 80 wt. % or no greater than 70 wt. % or no greater than 60 wt. % or no greater than 50 wt. % or no greater than 40 wt. % or no greater than 30 wt. % or no greater than 20 wt. % or no greater than 10 wt. % lime fines. It will be appreciated that the lime fines content can be between any of the minimum and maximum values noted above, including for example, but not limited to, at least 80 wt. % and not greater than 99 wt. % or at least 95 wt. % and no greater than 99 wt. %.

In an embodiment, the shell composition may include a particular content hydrated lime that may facilitate improved performance and/or manufacturing of the asphalt pellets. The hydrated lime may also provide for reduced environmental impact. In an embodiment the shell can include at least 5 wt. % hydrated lime or at least 10 wt. % or at least 15 wt. % or at least 20 wt. % or at least 25 wt. % or at least 30 wt. % or at least 35 wt. % or at least 40 wt. % or at least 45 wt. % or at least 50 wt. % or at least 55 wt. % or at least 60 wt. % or at least 65 wt. % or at least 70 wt. % or at least 75 wt. % or at least 80 wt. % or at least 85 wt. % or at least 90 wt. % or at least 95 wt. % or at least 97 wt. % hydrated lime. In an embodiment, the shell can include no greater than 99 wt. % hydrated lime or no greater than 90 wt. % or no greater than 80 wt. % or no greater than 70 wt. % or no greater than 60 wt. % or no greater than 50 wt. % or no greater than 40 wt. % or no greater than 30 wt. % or no greater than 20 wt. % or no greater than 10 wt. % hydrated lime. It will be appreciated that the hydrated lime content can be between any of the minimum and maximum values noted above, including for example, but not limited to, at least 80 wt. % and not greater than 99 wt. % or at least 95 wt. % and no greater than 99 wt. %.

In an embodiment, the shell composition can further include a water resistant agent or an adhesive. The water resistant agent or adhesive can be lignin. The adhesive and water resistant agent can be fed from tanks 212 and 213 to be mixed with water in tank 214. The adhesive and water resistant agent solution can then be fed into pelletizer disc 222 to be agglomerated as part of the shell composition. In an alternative embodiment, the shell can include a hydrophobic polymer, a hydrophilic polymer, a hydrophobic cellulose, a polyvinyl alcohol, molasses or molasses derivatives, latex, polysaccharides, or latex.

In an embodiment, the shell composition can further include an additive that may facilitate improved performance and/or manufacturing of the asphalt pellet. The additive may also provide for reduced environmental impact. In an embodiment, the additive can be tire rubber, asphalt, aramid fibers, carbon, asphalt additives, glass, recycled material, recycled asphalt pavement, Fisher-Tropsch wax, soy wax, zeolites, high density polyethylethe (HDPE), low density polyethelene (LDPE), ethylene-vinyl acetate (EVA), polyvinyl chloride (PVC), an emulsifying agent, polyciclic aromatic hydrocarbons (PAHs), sodium polyacrylate polymers, styrene butadiene styrene rubbers (SBS), styrene butadiene rubbers (SBR), paper, carbon black, a colorant, cellulose, or a combination thereof.

In an embodiment, the shell composition may include a particular content of asphalt shingle waste that may facilitate improved performance and/or manufacturing of the asphalt pellets. The asphalt shingle waste content may also provide for reduced environmental impact. In an embodiment, the shell composition may include no greater than 5 wt. % asphalt shingle waste or less than 4 wt. % recycled asphalt shingle waste or less than 3 wt. % or less than 2 wt. % or less than 1 wt. %. In an embodiment, the shell composition can be essentially free of asphalt shingle waste.

Following pelletizer disc 222, the shelled pellets 100 can be transported to dryer 241 via conveyer belt 233. The pellets can be dried at a temperature of 120-160° F. The pellets can be dried until essentially all water in the shell has evaporated.

In an embodiment, the pellets can have a particular average crush strength, which may facilitate improved performance and/or manufacturing of the pellets. The crush strength may also provide for reduced environmental impact. In an embodiment, the pellets can have a crush strength of at least 20 N or at least 25 N or at least 30 N or at least 35 N or at least 40 N or at least 45 N or at least 50 N. In an embodiment, the batch can have a crush strength of no greater than 100 N. It will be appreciated that crush strength may be within a range having any of the minimum and maximum values noted above.

The crush strength can be measured according to the methods outlined in the examples section below.

In an embodiment, the asphalt content in the pellets have a particular low temperature performance grade that may facilitate improved performance and/or manufacturing of the asphalt pellets. The low temperature performance grade may also provide for reduced environmental impact. In an embodiment, the asphalt can have a low temperature performance grade of no greater than 0° C. or no greater than −2° C. or no greater than −4° C. or no greater than −6° C. or no greater than −8° C. or no greater than −10° C. or no greater than −12° C. or no greater than −14° C. or no greater than −16° C. or no greater than −8° C. or no greater than −20° C. or no greater than −22° C. or no greater than −24° C. or no greater than −26° C. In another embodiment the asphalt can have a low temperature performance grade of at least −50° C. or at least −48° C. or at least −46° C. or at least −44° C. or at least −42° C. or at least −40° C. It will be appreciated that the low temperature performance grade may be between any of the minimum and maximum values noted above.

In an embodiment, the asphalt content in the pellets may have a particular high temperature performance grade that may facilitate improved performance and/or manufacturing of the asphalt pellets. The high temperature performance grade may also provide for reduced environmental impact. In an embodiment, the asphalt can have a high temperature performance grade of at least 50° C. or at least 52° C. or at least 54° C. or at least 56° C. or at least 58° C. or at least 60° C. or at least 62° C. or at least 64° C. or at least 66° C. or at least 68° C. or at least 70° C. or at least 72° C. or at least 74° C. or at least 76° C. or at least 78° C. or at least 80° C. In another embodiment the asphalt can have a high temperature performance grade of less than 100° C. or less than 98° C. or less than 96° C. or less than 94° C. or less than 92° C. or less than 90° C. It will be appreciated that the high temperature performance grade may be between any of the minimum and maximum values noted above.

Pavement grading is conducted in accordance with AASHTO R29 and AASHTO M320. The pavement grade is a characteristic of the asphalt within the pellets. The low temperature and high temperature performance grades are indicative of the lowest and highest temperatures at which the asphalt compositions can perform as pavement in low traffic conditions without failure.

### EMBODIMENTS

Embodiment 1. An asphalt pellet comprising:
a core comprising an asphalt binder,
a shell comprising stucco.

Embodiment 2. The pellet of embodiment 1, wherein the pellet comprises a crush strength of at least 1 psi or at least 2 psi or at least 3 psi or at least 4 psi or at least 5 psi or at least 6 psi or at least 7 psi or at least 8 psi or at least 9 psi or at least 10 psi or at least 11 psi or at least 12 psi or at least 13 psi or at least 14 psi or at least 15 psi or at least 25 psi or at least 50 psi or at least 75 psi or at least 100 psi or at least 125 psi or at least 150 psi or at least 175 psi or at least 200 psi or at least 225 psi or at least 250 psi or at least 275 psi or at least 300 psi.

Embodiment 3. The pellet of embodiment 1, wherein the pellet comprises a crush strength of not greater than 350 psi.

Embodiment 4. The pellet of embodiment 1, wherein the core further comprises asphalt shingle waste.

Embodiment 5. The pellet of embodiment 1, wherein the pellet comprises a low temperature performance grade of no greater than 0° C. or no greater than −2° C. or no greater than −4° C. or no greater than −6° C. or no greater than −8° C. or no greater than −10° C. or no greater than −12° C. or no greater than −14° C. or no greater than −16° C. or no greater than −18° C. or no greater than −20° C. or no greater than −22° C. or no greater than −24° C. or no greater than −26° C.

Embodiment 6. The pellet of embodiment 1, wherein the pellet comprises a low temperature performance grade of at least −50° C. or at least −48° C. or at least −46° C. or at least −44° C. or at least −42° C. or at least −40° C.

Embodiment 7. The pellet of embodiment 1, wherein the asphalt pellet comprises a high temperature performance grade of at least 50° C. or at least 52° C. or at least 54° C. or at least 56° C. or at least 58° C. or at least 60° C. or at least 62° C. or at least 64° C. or at least 66° C. or at least 68° C. or at least 70° C. or at least 72° C. or at least 74° C. or at least 76° C. or at least 78° C. or at least 80° C.

Embodiment 8. The pellet of embodiment 1, wherein the asphalt pellet comprises a high temperature performance grade of less than 100° C. or less than 98° C. or less than 96° C. or less than 94° C. or less than 92° C. or less than 90° C.

Embodiment 9. The pellet of embodiment 4, wherein the asphalt shingle waste comprises post consumer waste, post industrial waste, or a combination thereof.

Embodiment 10. The pellet of embodiment 4, wherein the core comprises at least 5 wt % asphalt shingle waste or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % asphalt shingle waste.

Embodiment 11. The pellet of embodiment 4, wherein the core comprises no greater than 99 wt % asphalt shingle waste or no greater than 98 wt % or no greater than 97 wt % or no greater than 96 wt % or no greater 95 wt % or no greater than 94 wt % or no greater than 93 wt % or no greater than 92 wt % asphalt shingle waste.

Embodiment 12. The pellet of embodiment 1, wherein the core further comprises a softening agent.

Embodiment 13. The pellet of embodiment 12, wherein the core comprises at least 1 wt % softening agent or at least 2 wt % or at least 3 wt % or at least 4 wt % or at least 5 wt % or at least 6 wt % or at least 7 wt % or at least 8 wt % softening agent.

Embodiment 14. The pellet of embodiment 12, wherein the core comprises no greater than no greater than 30 wt. % softening agent or no greater than 25 wt. % or no greater than 20 wt. % or no greater than 15 wt. % or no greater than 10 wt. % softening agent.

Embodiment 15. The pellet of embodiment 12, wherein the softening agent comprises a petroleum distillate, performance grade asphalt, bio-oil, a vegetable oil, biofuel, a biodiesel, a biodiesel residue oil, Tall-oil, HVGO, FAME, reembodimented motor oil, reembodimented cutting oil, pine tar or a combination thereof.

Embodiment 16. The pellet of embodiment 12, wherein the softening agent comprises a biodiesel residue oil.

Embodiment 17. The pellet of embodiment 1, wherein the core further comprises an additive.

Embodiment 18. The pellet of embodiment 17, wherein the additive comprises tire rubber, asphalt, aramid fibers, carbon, asphalt additives, glass, recycled material, recycled asphalt pavement, Fisher-Tropsch wax, soy wax, zeolites, high density polyethylethe (HDPE), low density polyethelene (LDPE), ethylene-vinyl acetate (EVA), polyvinyl chloride (PVC), an emulsifying agent, polyciclic aromatic hydrocarbons (PAHs), sodium polyacrylate polymers, styrene butadiene styrene rubbers (SBS), styrene butadiene rubbers (SBR), paper, carbon black, a colorant, cellulose, or a combination thereof.

Embodiment 19. The pellet of embodiment 1, wherein the core comprises a diameter of at least 0.01 in. and no greater than 0.5 in.

Embodiment 20. The pellet of embodiment 1, wherein the pellet comprises a diameter of at least 0.01 in. and no greater than 2 in.

Embodiment 21. The pellet of embodiment 1, wherein the shell comprises less than 5 wt % asphalt shingle waste or less than 4 wt % or less than 3 wt % or less than 2 wt % or less than 1 wt %.

Embodiment 22. The pellet of embodiment 1, wherein the shell is essentially free of asphalt shingle waste.

Embodiment 23. The pellet of embodiment 1, wherein the shell comprises recycled polyethylene, a water-resistant polymer, a wax, mineral fines, or ground plastic fines, or a combination thereof.

Embodiment 24. The pellet of embodiment 1, wherein the shell comprises mineral fines.

Embodiment 25. The pellet of embodiment 1, wherein the shell comprises lime fines.

Embodiment 26. The pellet of embodiment 1, wherein the shell comprises hydrated lime.

Embodiment 27. The pellet of embodiment 1, wherein the shell comprises recycled gypsum.

Embodiment 28. The pellet of embodiment 1, wherein the shell comprises at least 5 wt % stucco or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 97 wt % stucco.

Embodiment 29. The pellet of embodiment 1, wherein the shell comprises no greater than 99 wt % stucco or no greater than 90 wt % or no greater than 80 wt % or no greater than 70 wt % or no greater than 60 wt % or no greater than 50 wt % or no greater than 40 wt % or no greater than 30 wt % or no greater than 20 wt % or no greater than 10 wt % stucco.

Embodiment 30. The pellet of embodiment 1, wherein the shell comprises at least 5 wt % mineral fines or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 97 wt % mineral fines.

Embodiment 31. The pellet of embodiment 1, wherein the shell comprises no greater than 99 wt % mineral fines or no greater than 90 wt % or no greater than 80 wt % or no greater than 70 wt % or no greater than 60 wt % or no greater than 50 wt % or no greater than 40 wt % or no greater than 30 wt % or no greater than 20 wt % or no greater than 10 wt % mineral fines.

Embodiment 32. The pellet of embodiment 1, wherein the shell comprises at least 5 wt % lime fines or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 97 wt % lime fines.

Embodiment 33. The pellet of embodiment 1, wherein the shell comprises no greater than 99 wt % lime fines or no greater than 90 wt % or no greater than 80 wt % or no greater than 70 wt % or no greater than 60 wt % or no greater than 50 wt % or no greater than 40 wt % or no greater than 30 wt % or no greater than 20 wt % or no greater than 10 wt % lime fines.

Embodiment 34. The pellet of embodiment 1, wherein the shell comprises at least 5 wt % hydrated lime or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 97 wt % hydrated lime.

Embodiment 35. The pellet of embodiment 1, wherein the shell comprises no greater than 99 wt % hydrated lime or no greater than 90 wt % or no greater than 80 wt % or no greater than 70 wt % or no greater than 60 wt % or no greater than 50 wt % or no greater than 40 wt % or no greater than 30 wt % or no greater than 20 wt % or no greater than 10 wt % hydrated lime.

Embodiment 36. The pellet of embodiment 1, wherein the shell further comprises a water resistant agent.

Embodiment 37. The pellet of embodiment 1, wherein the shell further comprises an adhesive.

Embodiment 38. The pellet of embodiment 1, wherein the shell further comprises lignin.

Embodiment 39. The pellet of embodiment 1, wherein the shell further comprises a hydrophobic polymer, a hydrophilic polymer, a hydrophobic cellulose, a polyvinyl alcohol, molasses or molasses derivatives, latex, polysaccharides, or latex, or any combination thereof.

Embodiment 40. The pellet of embodiment 1, wherein the shell further comprises a shell additive.

Embodiment 41. The pellet of embodiment 40, wherein the shell additive comprises tire rubber, asphalt, aramid fibers, carbon, asphalt additives, glass, recycled material, recycled asphalt pavement, Fisher-Tropsch wax, soy wax, zeolites, high density polyethylethe (HDPE), low density polyethelene (LDPE), ethylene-vinyl acetate (EVA), polyvinyl chloride (PVC), an emulsifying agent, polyciclic aromatic hydrocarbons (PAHs), sodium polyacrylate polymers, styrene butadiene styrene rubbers (SBS), styrene butadiene rubbers (SBR), paper, carbon black, a colorant, cellulose, or a combination thereof.

Embodiment 42. The pellet of embodiment 1, wherein the shell comprises 10-20 wt % of each pellet.

Embodiment 43. The pellet of embodiment 1, wherein the core comprises 80-90 wt % of each pellet.

Embodiment 44. A batch of asphalt pellets comprising the asphalt pellets of any one of embodiments 1-43.

Embodiment 45. A method of preparing a batch of asphalt pellets comprising:
agglomerating asphalt shingle a pelletizer to form asphalt pellet cores;
agglomerating the asphalt pellet cores with a shell composition to form asphalt pellets;
wherein the shell composition comprises stucco.

Embodiment 46. The method of embodiment 45, further comprising dusting the asphalt pellet cores with a mineral powder before agglomerating the asphalt pellet cores with the shell composition.

Embodiment 47. The method of embodiment 45, further comprising drying the coated pellets.

Embodiment 48. The method of embodiment 45, further comprising drying the coated pellets at a temperature of 120-160° F.

Embodiment 49. The method of embodiment 45, wherein the method does not include drying the pellets.

Embodiment 50. The method of embodiment 45, wherein the pellets comprise an average crush strength of at least 1 psi or at least 2 psi or at least 3 psi or at least 4 psi or at least 5 psi or at least 6 psi or at least 7 psi or at least 8 psi or at least 9 psi or at least 10 psi or at least 11 psi or at least 12 psi or at least 13 psi or at least 14 psi or at least 15 psi or at least 25 psi or at least 50 psi or at least 75 psi or at least 100 psi or at least 125 psi or at least 150 psi or at least 175 psi or at least 200 psi or at least 225 psi or at least 250 psi or at least 275 psi or at least 300 psi.

Embodiment 51. The method of embodiment 45, wherein the pellets comprise an average crush strength of not greater than 350 psi.

Embodiment 52. The method of embodiment 45, wherein the core further comprises asphalt shingle waste.

Embodiment 53. The method of embodiment 45, wherein the batch of asphalt pellets comprises a low temperature performance grade of no greater than 0° C. or no greater than −2° C. or no greater than −4° C. or no greater than −6° C. or no greater than −8° C. or no greater than −10 ° C. or no greater than −12° C. or no greater than −14° C. or no greater than −16° C. or no greater than −18° C. or no greater than −20° C. or no greater than −22° C. or no greater than −24° C. or no greater than −26° C.

Embodiment 54. The method of embodiment 45, wherein the batch comprises a low temperature performance grade of at least −50° C. or at least −48° C. or at least −46° C. or at least −44° C. or at least −42° C. or at least −40° C.

Embodiment 55. The method of embodiment 45, wherein the batch of asphalt pellets comprises a high temperature performance grade of at least 50° C. or at least 52° C. or at least 54° C. or at least 56° C. or at least 58° C. or at least 60° C. or at least 62° C. or at least 64° C. or at least 66° C. or at least 68° C. or at least 70° C. or at least 72° C. or at least 74° C. or at least 76° C. or at least 78° C. or at least 80° C.

Embodiment 56. The method of embodiment 45, wherein the batch of asphalt pellets comprises a high temperature performance grade of less than 100° C. or less than 98° C. or less than 96° C. or less than 94° C. or less than 92° C. or less than 90° C.

Embodiment 57. The method of embodiment 52, wherein the asphalt shingle waste comprises post consumer waste, post industrial waste, or a combination thereof.

Embodiment 58. The method of embodiment 52, wherein the core comprises at least 5 wt % asphalt shingle waste or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % asphalt shingle waste.

Embodiment 59. The method of embodiment 52, wherein the core comprises no greater than 99 wt % asphalt shingle waste or no greater than 98 wt % or no greater than 97 wt % or no greater than 96 wt % or no greater than 95 wt % or no greater than 94 wt % or no greater than 93 wt % or no greater than 92 wt % asphalt shingle waste.

Embodiment 60. The method of embodiment 45, wherein the core further comprises a softening agent.

Embodiment 61. The method of embodiment 60, wherein the core comprises at least 1 wt % softening agent or at least 2 wt % or at least 3 wt % or at least 4 wt % or at least 5 wt % or at least 6 wt % or at least 7 wt % or at least 8 wt % softening agent.

Embodiment 62. The method of embodiment 60, wherein the core comprises no greater than 10 wt % softening agent.

Embodiment 63. The method of embodiment 60, wherein the softening agent comprises a petroleum distillate, performance grade asphalt, bio-oil, a vegetable oil, biofuel, a biodiesel, a biodiesel residue oil, Tall-oil, HVGO, FAME, reembodimented motor oil, reembodimented cutting oil, pine tar or a combination thereof.

Embodiment 64. The method of embodiment 60, wherein the softening agent comprises a biodiesel residue oil.

Embodiment 65. The method of embodiment 45, wherein the core further comprises an additive.

Embodiment 66. The method of embodiment 65, wherein the additive comprises tire rubber, asphalt, aramid fibers, carbon, asphalt additives, glass, recycled material, recycled asphalt pavement, Fisher-Tropsch wax, soy wax, zeolites, high density polyethylethe (HDPE), low density polyethelene (LDPE), ethylene-vinyl acetate (EVA), polyvinyl chloride (PVC), an emulsifying agent, polyciclic aromatic hydrocarbons (PAHs), sodium polyacrylate polymers, styrene butadiene styrene rubbers (SBS), styrene butadiene rubbers (SBR), paper, carbon black, a colorant, cellulose, or a combination thereof.

Embodiment 67. The method of embodiment 45, wherein the core comprises a diameter of at least 0.01 in and no greater than 0.5 in.

Embodiment 68. The method of embodiment 45, wherein the pellets comprise a diameter of at least 0.01 in and no greater than 2 in.

Embodiment 69. The method of embodiment 45, wherein the shell comprises less than 5 wt % asphalt shingle waste or less than 4 wt % or less than 3 wt % or less than 2 wt % or less than 1 wt %.

Embodiment 70. The method of embodiment 45, wherein the shell is essentially free of asphalt shingle waste.

Embodiment 71. The method of embodiment 45, wherein the shell comprises recycled polyethylene, a water-resistant polymer, a wax, mineral fines, or ground plastic fines, or a combination thereof.

Embodiment 72. The method of embodiment 45, wherein the shell comprises mineral fines.

Embodiment 73. The method of embodiment 45, wherein the shell comprises lime fines.

Embodiment 74. The method of embodiment 45, wherein the shell comprises hydrated lime.

Embodiment 75. The method of embodiment 45, wherein the shell comprises recycled gypsum.

Embodiment 76. The method of embodiment 45, wherein the shell comprises at least 5 wt % stucco or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 97 wt % stucco.

Embodiment 77. The method of embodiment 45, wherein the shell comprises no greater than 99 wt % stucco or no greater than 90 wt % or no greater than 80 wt % or no greater than 70 wt % or no greater than 60 wt % or no greater than 50 wt % or no greater than 40 wt % or no greater than 30 wt % or no greater than 20 wt % or no greater than 10 wt % stucco.

Embodiment 78. The method of embodiment 45, wherein the shell comprises at least 5 wt % mineral fines or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 97 wt % mineral fines.

Embodiment 79. The method of embodiment 45, wherein the shell comprises no greater than 99 wt % mineral fines or no greater than 90 wt % or no greater than 80 wt % or no greater than 70 wt % or no greater than 60 wt % or no greater than 50 wt % or no greater than 40 wt % or no greater than 30 wt % or no greater than 20 wt % or no greater than 10 wt % mineral fines.

Embodiment 80. The method of embodiment 45, wherein the shell comprises at least 5 wt % lime fines or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 97 wt % lime fines.

Embodiment 81. The method of embodiment 45, wherein the shell comprises no greater than 99 wt % lime fines or no greater than 90 wt % or no greater than 80 wt % or no greater than 70 wt % or no greater than 60 wt % or no greater than 50 wt % or no greater than 40 wt % or no greater than 30 wt % or no greater than 20 wt % or no greater than 10 wt % lime fines.

Embodiment 82. The method of embodiment 45, wherein the shell comprises at least 5 wt % hydrated lime or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 97 wt % hydrated lime.

Embodiment 83. The method of embodiment 45, wherein the shell comprises no greater than 99 wt % hydrated lime or no greater than 90 wt % or no greater than 80 wt % or no greater than 70 wt % or no greater than 60 wt % or no greater than 50 wt % or no greater than 40 wt % or no greater than 30 wt % or no greater than 20 wt % or no greater than 10 wt % hydrated lime.

Embodiment 84. The method of embodiment 45, wherein the shell further comprises a water resistant agent.

Embodiment 85. The method of embodiment 45, wherein the shell further comprises an adhesive.

Embodiment 86. The method of embodiment 45, wherein the shell further comprises lignin.

Embodiment 87. The method of embodiment 45, wherein the shell further comprises a hydrophobic polymer, a hydrophilic polymer, a hydrophobic cellulose, a polyvinyl alcohol, molasses or molasses derivatives, latex, polysaccharides, or latex, or any combination thereof.

Embodiment 88. The method of embodiment 45, wherein the shell further comprises a shell additive.

Embodiment 89. The method of embodiment 88, wherein the shell additive comprises tire rubber, asphalt, aramid fibers, carbon, asphalt additives, glass, recycled material, recycled asphalt pavement, Fisher-Tropsch wax, soy wax, zeolites, high density polyethylethe (HDPE), low density polyethelene (LDPE), ethylene-vinyl acetate (EVA), polyvinyl chloride (PVC), an emulsifying agent, polyciclic aromatic hydrocarbons (PAHs), sodium polyacrylate polymers, styrene butadiene styrene rubbers (SBS), styrene butadiene rubbers (SBR), paper, carbon black, a colorant, cellulose, or a combination thereof.

Embodiment 90. The method of embodiment 45, wherein the shell comprises 10-20 wt % of each pellet.

Embodiment 91. The method of embodiment 45, wherein the core comprises 80-90 wt % of each pellet.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EXAMPLES

### Example 1—Preparation of Pellets

Samples S1, S2, CS1, and CS2 were prepared according to the following steps having the composition outline in Table 1.

TABLE 1

| | | | | |
|---|---|---|---|---|
| Sample | S1 | S2 | CS1 | CS2 |

Core Composition

| | | | | |
|---|---|---|---|---|
| Recycled | 92-96 | 92-96 | 92-96 | 92-96 |
| Asphalt Shingle | wt. % | wt. % | wt. % | wt. % |
| (Post Industrial) | | | | |
| Softening Agent | 4-8 wt. % | 4-8 | 4-8 | 4-8 |
| | | wt. % | wt. % | wt. % |

Shell Composition

| | | | | |
|---|---|---|---|---|
| Calcined | 100 wt. % | 100 | 75 wt. % | 75 wt. % |
| gypsum | | wt. % | | |
| Fresh Gypsum | 0 wt. % | 0 wt. % | 0 wt. % | 0 wt. % |
| Hydrated Lime | 0 wt. % | 0 wt. % | 25 wt. % | 25 wt. % |

Water Resistant Binder Composition

| | | | | |
|---|---|---|---|---|
| Water | 47-50 | 47-50 | 47-50 | 47-50 |
| | wt. % | wt. % | wt. % | wt. % |
| Water resistant | 0.01-3 | 0.01-3 | 0.01-3 | 0.01-3 |
| agent | wt. % | wt. % | wt. % | wt. % |
| (ZycoTherm) | | | | |
| Lignin (Norlig G | 47-50 | 47-50 | 47-50 | 47-50 |
| from | wt. % | wt. % | wt. % | wt. % |
| LignoTech) | | | | |

Pellet cores were prepared in a pelletizer disc having the composition detailed above in Table 1. The core materials were pelletized until the cores had a diameter of about 0.25-0.5 in. The softening agent included Bio-Residue Oil from renewable energy group (REG). The pellet cores are dusted with a light layer of silica fines in order to prevent sticking. The cores are transported to a second pelletizer disc where the shell composition and water resistant binder composition are applied until the shelled cores have a diameter of about 0.5-1 in.

The pellets were then dried for 48 hours at a temperature of 80° F. to simulate an optimum curing temperature. Then the pellets were sieved on a mechanical aggregate shaker making sure to have a ½″ sieve and a ⅜″ sieve in the sieve stack. The ½″ by ⅜″ pellets were collected for crush strength testing according to a modified ASTM Test D4179-01. 15 pellets from each sample set were tested.

Crush strength was measured using a MTS Sintech 5G Test Frame with a 6″ diameter compression base platen, 1″ diameter top push rod, preload of 1-5 N and a displacement rate of 10 mm/minute. The force when cracking was initiated was noted for each sample. Results for each sample can be found below in table 2. Load vs displacement curves can be found in FIGs.

TABLE 2

| Sample # | Average crush strength |
|---|---|
| S1 | 61.02 |
| S2 | 54.32 |
| CS1 | 14.43 |
| Cs2 | 15.77 |

What is claimed is:

1. An asphalt pellet comprising:
a core comprising an asphalt binder,
a shell comprising calcined gypsum.

2. The pellet of claim 1, wherein the pellet comprises a crush strength of at least 20 N.

3. The pellet of claim 1, wherein the core further comprises asphalt shingle waste.

4. The pellet of claim 1, wherein the pellet comprises a low temperature performance grade of no greater than 0° C.

5. The pellet of claim 1, wherein the asphalt pellet comprises a high temperature performance grade of at least 50° C.

6. The pellet of claim 3, wherein the asphalt shingle waste comprises post consumer waste, post industrial waste, or a combination thereof.

7. The pellet of claim 1, wherein the core further comprises a softening agent.

8. A batch of asphalt pellets, each pellet comprising:
a core comprising an asphalt binder,
a shell comprising calcined gypsum.

9. The batch of claim 8, wherein the batch comprises an average crush strength of at least 20 N.

10. The batch of claim 8, wherein the core of each pellet further comprises asphalt shingle waste.

11. The batch of claim 8, wherein the pellets comprise a low temperature performance grade of no greater than 0° C.

12. The batch of claim 8, wherein the asphalt pellets comprise a high temperature performance grade of at least 50° C.

13. The batch of claim 10, wherein the asphalt shingle waste comprises post consumer waste, post industrial waste, or a combination thereof.

14. A method of preparing a batch of asphalt pellets comprising:
agglomerating asphalt shingle a pelletizer to form asphalt pellet cores;
agglomerating the asphalt pellet cores with a shell composition to form asphalt pellets;
wherein the shell composition comprises calcined gypsum.

15. The method of claim 14, further comprising dusting the asphalt pellet cores with a mineral powder before agglomerating the asphalt pellet cores with the shell composition.

16. The method of claim 14, further comprising drying the coated pellets.

17. The method of claim 14, wherein the method does not include drying the pellets.

18. The method of claim 14, wherein the pellets comprise an average crush strength of at least 20 N.

19. The method of claim 14, wherein the core further comprises asphalt shingle waste.

20. The method of claim 19, wherein the asphalt shingle waste comprises post consumer waste, post industrial waste, or a combination thereof.
